(19) United States
(12) Patent Application Publication
(10) Pub. No.: US 2016/0322666 A1
(43) Pub. Date: Nov. 3, 2016

(54) SOLID ELECTROLYTE AND ALL-SOLID STATE BATTERY COMPRISING THE SAME

(71) Applicant: Hyundai Motor Company, Seoul (KR)

(72) Inventors: Kyung Su Kim, Yongin (KR); Yong Sub Yoon, Soeul (KR); Hong Seok Min, Yongin (KR)

(21) Appl. No.: 14/947,778

(22) Filed: Nov. 20, 2015

(30) Foreign Application Priority Data
Apr. 29, 2015 (KR) 10-2015-0060392

(51) Int. Cl. H01M 10/0562; H01M 10/052

(52) U.S. Cl. CPC H01M 10/0562; H01M 10/052; H01M 2300/0068

(57) ABSTRACT

Disclosed is a solid electrolyte formed by coating an oxide-based lithium ion conductor on a sulfide-based compound. When an all-solid state battery is manufactured using the solid electrolyte of the present invention, interface resistance between the solid electrolyte and electrode materials may be reduced, and possibility of damage of a coated layer on a process of manufacturing the electrode such as pressing may be reduced, thereby improving output and life time of the battery. Further, storage and use may become easy because the solid electrolyte may be protected from moisture and oxygen in the air, thereby improving manufacturing efficiency of the battery.

### CROSS-REFERENCE TO RELATED APPLICATION

This application claims under 35 U.S.C. §119(a) the benefit of Korean Patent Application No. 10-2015-0060392 filed on Apr. 29, 2015, the entire contents of which are incorporated herein by reference.

### TECHNICAL FIELD

The present invention relates to a solid electrolyte. The solid electrolyte may comprise a core comprising a sulfide-based compound and a coating comprising an oxide-based lithium ion conductor. When the solid electrolyte is used in all-solid state battery, interface resistance with electrode materials may be reduced, damage of the coated layer from the manufacturing process of the electrode such as pressing may be prevented. Thus, the all-solid state battery having increased output and life time can be manufactured. Further, because the coating protects the core from moisture and oxygen in the air, storage and use of the solid electrolyte may become easy.

### BACKGROUND

Recently, a rechargeable secondary battery has been widely used as a large capacity power storage battery for an electric vehicle or a power storage system as well as a small high performance energy source for portable electronic devices such as a mobile phone, a camcorder, a notebook and the like.

Among the secondary battery, a lithium ion battery can provide higher energy density and larger capacity per unit area than a nickel-manganese battery or a nickel-cadmium battery. However, the conventional lithium ion battery has used an inflammable organic liquid electrolyte as an electrolyte, and thus, safety problem may be caused by overheating and the like.

Alternatively, an all-solid state battery using a nonflammable solid electrolyte also has been used. However, in the conventional all-solid state battery, large interface resistance may be generated when a lithium ion deficient layer is formed on the interface of a sulfide-based solid electrolyte and an oxide-based electrode material, movement of lithium ions between the electrode and the electrolyte may be reduced, and thus battery capacity, short life time and the like may be reduced.

In the related arts, Korean Patent Laid-Open Publication No. 10-2012-0016079 has disclosed a method for coating the surface of a positive electrode active material with an oxide to reduce interface resistance. However, the coated layer may be easily broken by external pressure on a process of manufacturing a battery such as pressing and the like, or the coated layer may be damaged by volume change of the positive electrode active material when a battery is charged and discharged.

The above information disclosed in this Background section is only for enhancement of understanding of the background of the invention and therefore it may contain information that does not form the prior art that is already known in this country to a person of ordinary skill in the art.

### SUMMARY

In preferred aspects, the present invention provides a solid electrolyte. The solid electrolyte of the invention may reduce interfacial resistance between the electrode and the solid electrolyte, such that the solid electrolyte can be used in an all-solid state battery to provide high battery capacity and long life time.

In one aspect, provided is a solid electrolyte. Preferably, the solid electrolyte may be in a form of a particle. The solid electrolyte may comprise: a core and a coating.

In particular, the core may be an inner portion of the solid electrolyte, and may be suitably formed at least 0.1 nm, at least 1 nm, at least 10 nm, at least 100 nm, or at least 500 nm below from the surface of the solid electrolyte. The core may suitably have a shape of a sphere, oval or other polyhedral, however, the core can be formed in any shape or configuration without limitation. Further, the core may have a diameter, from the center to the outmost surface, of about 10 nm to 20 μm, of about 100 nm to 15 μm, or particularly of about of about 500 nm to a 10 μm. In particular, the core may comprise a sulfide-based compound.

In addition, the coating may be an outer portion of the solid electrolyte, which may surround at least a portion or entire portion of the core. The coating may be disposed or attached to the surface of the core, uniformly or non-uniformly based on portions. Further, the coating may suitably have a thickness of about 0.1 nm to 500 nm, or particularly of about 1 nm to 100 nm formed on the surface of the core, without limitations to portion of the surface. In particular, the coating may comprise an oxide-based lithium ion conductor as being coated on the surface of the core.

In a preferred embodiment, the sulfide-based compound may comprise at least one selected from the group consisting of Li₂S—P₂S₅, Li₁₀GeP₂S₁₂ and Li₆PS₅Cl.

In a preferred embodiment, the oxide-based lithium ion conductor may comprise at least one selected from the group consisting of LiNbO₃, Li₃PO₄, Li₂ZrO₃, Li₂WO₄, TaO₃ and Li₄SiO₄.

In a preferred embodiment, a thickness of the coating may be from about 1 to about 100 nm.

In a preferred embodiment, the coating may be rigidly coated by interaction between a sulfur atom of the core and an oxygen atom of the oxide-based lithium ion conductor.

In a preferred embodiment, the oxide-based lithium ion conductor may reduce interface resistance by inhibiting or reducing formation of a lithium ion deficient layer on the core.

In another aspect, the present invention provides a method for manufacturing the solid electrolyte. The method may comprise: coating an oxide-based lithium ion conductor on a sulfide-based compound. In particular, the coating may be performed by using a sol-gel method or a spray coating method.

Further provided is an all-solid state battery that comprises the solid electrolyte as described above.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 illustrates an interface between a positive electrode active material and a solid electrolyte in a conventional all-solid state battery;

FIG. 2 illustrates an interface between a positive electrode active material and an exemplary solid electrolyte according to an exemplary embodiment to the present invention in an all-solid state battery; and

FIG. 3 is an exemplary graph showing charging and discharging capacities and life time of all-solid state batteries manufactured in Example and Comparative Example of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, Embodiments of the present invention will be described in detail. However, the embodiments of the present invention may be modified in various ways, and the scope of the present invention should not be interpreted as being limited to the examples. The embodiments of the present invention are provided just for explaining the present invention more perfectly to those having ordinary skill in the art.

In general, an all-solid state battery comprises a positive electrode, a negative electrode and a solid electrolyte membrane interposed between the positive electrode and the negative electrode.

The positive electrode comprises a solid electrolyte, a positive electrode active material, a conductive material, a binder and the like. As the solid electrolyte, a sulfide-based compound may be used, and as the positive electrode active material, an oxide-based compound may be used.

Thus, in the all-solid state battery, the interface between the sulfide-based compound and the oxide-based compound may be formed between the positive electrode and the solid electrolyte membrane, or between the positive electrode active material and the solid electrolyte. Hereinafter, the “interface” means surface areas where the sulfide-based compound and the oxide-based compound are contacted.

At the interface in the all-solid state battery, an ion and an electron conductor from materials having different properties may contact and a contact potential difference may be generated on the interface. Particularly, since bonding force between a sulfur atom and lithium atom of the solid electrolyte is smaller than bonding force between an oxygen atom and a lithium atom of the positive electrode active material, the lithium ion may move from the solid electrolyte to the positive electrode active material. As such, a “lithium ion deficient layer” may be formed as a space charge layer is generated. Consequently, the lithium ion may not sufficiently move due to large interface resistance caused by the lithium ion deficient layer, and therefore capacity and life time of a battery may be reduced.

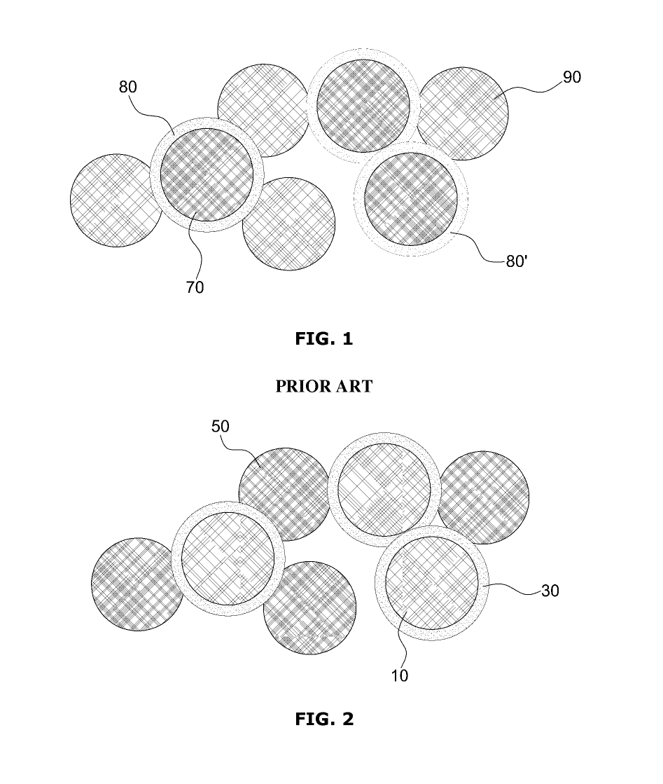

FIG. 1 is illustrates a positive electrode active material 70 and a solid electrolyte 90 of a conventional all-solid state battery. In order to reduce interface resistance between the positive electrode active material 70 and the solid electrolyte 90, a coated layer 80 is formed on the positive electrode active material 70.

However, for example, during the process of manufacturing a battery such as press molding and the like, the coated layer 80 formed to the positive electrode active material 70 may be damaged by external pressure or impact, which is presented as the coated layer 80′. Since both of the positive electrode active material 70 and the coated layer 80 are made of rigid oxide materials, those may be easily damaged on external pressure.

Further, because volume of the positive electrode active material 70 is changed by oxidation and reduction reaction during charging and discharging of the all-solid state battery, the coated layer 80′ may be damaged.

In FIG. 2, an exemplary solid electrolyte comprises a core 10 comprising a sulfide-based compound, and a coating 30 comprising an oxide-based lithium ion conductor formed on the surface of the core 10.

FIG. 2 also illustrates the interfaces between the solid electrolyte comprising the core 10 and the coating 30 and the positive electrode active material 50. The positive electrode active material 50 may be an oxide-based compound.

The positive electrode active material 50 may be an oxide-based compound, and the coating 30 of the solid electrolyte may be an oxide-based lithium ion conductor. The positive electrode active material (oxide-based compound) may have both of electron conductivity and lithium conductivity, but the coating (i.e. oxide-based lithium ion conductor) may have only lithium conductivity without electron conductivity. Details will be described below.

According to an exemplary embodiment, the core 10 may be the sulfide-based compound and serve substantially as a solid electrolyte in the all-solid state battery.

The sulfide-based compound may be any sulfide-based compound, which can be commonly used as a solid electrolyte in the all-solid state battery, but preferably it may comprise at least one selected from the group consisting of Li₂S—P₂S₅, Li₁₀GeP₂S₁₂, Li₆PS₅Cl and a mixture thereof.

Conventionally, the oxide-based lithium ion conductor is coated on the oxide-based positive electrode active material, and thus, the coating may be damaged when external pressure is added due to rigid characteristic of an oxide.

On the contrary, in the solid electrolyte according to an exemplary embodiment of the present invention, the core 10 may comprise a soft sulfide-based compound, and thus, when external pressured is added, impact may be absorbed and the coating part 30 can be stably maintained.

The coating 30 may be formed by coating the oxide-based lithium ion conductor to the surface of the core 10. The coating 30 may serve as a buffer layer between the core 10 and the positive electrode active material.

Binding force of the oxygen atom and the lithium atom of the coating part is stronger than the sulfur atom and the lithium atom of the core part, but weaker than the oxygen atom and the lithium atom of the positive electrode active material. Thus, the contact potential difference may be reduced. Further, although the contact potential difference is generated, electrons may not move from the core 10 to the positive electrode active material 50, because the coating 30 does not have electron conductivity. As such, since there is no need of balancing charge therebetween (no potential), the lithium ion may not move from the core 10 to the positive electrode active material 50. Consequently, the coating 30 may reduce interface resistance by preventing formation of the lithium ion deficient layer in the core part.

Further, the coating 30 may prevent reaction of the core 10 with oxygen and moisture in the air. Thus, the solid electrolyte may be easily stored and used, and the all-solid state battery may be efficiently produced.

The oxide-based lithium ion conductor may comprise at least one selected from the group consisting of LiNbO₃, Li₃PO₄, Li₂ZrO₃, Li₂WO₄, TaO₃, Li₄SiO₄ and a mixture thereof.

The coating 30 may efficiently reduce interface resistance and protect the core 10 from oxygen and moisture and the like in the air. In particular, a thickness of the coating may be from about 0.1 nm to about 500 nm, or particularly from about 1 nm to about 100 nm. But, when the coating 30 is formed thicker than the above described range, movement of the lithium ion may be interrupted, thereby increasing interface resistance.

A method of manufacturing the solid electrolyte according to various exemplary embodiments of the present invention is also provided. The method may comprise forming a coating by coating the oxide-based lithium ion conductor on a core comprising the sulfide-based compound. The coating may be performed using a sol-gel method or a spray coating method.

In order to effectively reduce interface resistance and provide sufficient movement of the lithium ion, it may be important to form the coating 30 uniformly on the surface of the core 10. Preferably, the coating may be coated by using the sol-gel method or the spray coating method.

Further, the all-solid state battery according to the present invention may comprise a positive electrode, a negative electrode and a solid electrolyte membrane.

The positive electrode may comprise the positive electrode active material, a conductive material, a binder and the solid electrolyte. The positive electrode active material may be the oxide-based compound, and the conductive material and the binder may be any material, which can be commonly used to an all-solid state battery without limitation.

The positive electrode may comprise the positive electrode active material, the conductive material, the binder and the solid electrolyte in an amount of commonly used level when manufacturing the all-solid state battery. But, the conductive material or the binder may be omitted depending on the kind of the all-solid state battery, materials used and the like.

The negative electrode may be a lithium metal, a lithium foil and the like, or a mixture of a negative electrode active material, the conductive material and the binder. In addition, any material for the negative electrode, which can be used to an all-solid state battery, may be used without limitation.

The solid electrolyte membrane may be made of the solid electrolyte, and may be interposed between the positive electrode and the negative electrode. Thus, according to the present invention, interface resistance between the positive electrode active material and the solid electrolyte as well as interface resistance between the electrode and the solid electrolyte membrane may be reduced.

The all-solid state battery may further comprise a constitution such as a separator, a current collector and the like. This is the constitution is commonly used, and therefore, detailed description is omitted.

The all-solid state battery may be manufactured by a wet method and a dry method. Preferably, the dry method may be used because the solid electrolyte of the present invention has no risk of damage by external pressure.

### EXAMPLES

The following examples illustrate the invention and are not intended to limit the same.

### Example

(1) Manufacture of Solid Electrolyte

A core was prepared by using Li₂S—P₂5₅ as a sulfide-based compound, and LiNbO₃ as an oxide-based lithium ion conductor was evenly coated on the core by a spray coating method to manufacture a coating.

(2) Manufacture of All-Solid State Battery (Cell)

A positive electrode active material as an oxide-based compound, a conductive material and the solid electrolyte were mixed, and then pressurized to manufacture a positive electrode.

The solid electrolyte was placed on top of the positive electrode, and then compressed to form a solid electrolyte membrane, and a lithium foil was compressed on top of the solid electrolyte membrane to manufacture an all-solid state battery in the form of a cell.

### Comparative Example

The procedure of Example was repeated except forming the coating on the solid electrolyte to manufacture an all-solid state battery.

### Measuring Example

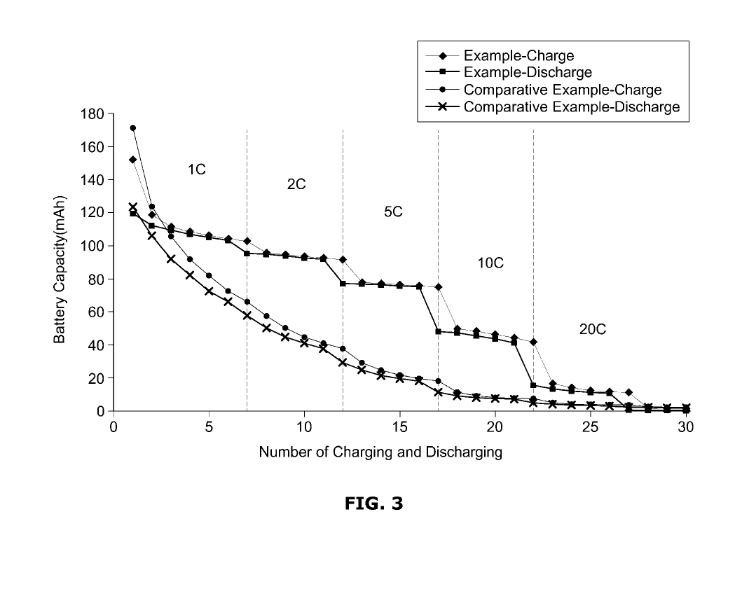

Charging and discharging capacities of the all-solid state batteries manufactured in Example and Comparative Example were measured. The charging and discharging cycle was repeated 30 times and then life time characteristic was measured. The results were as shown in FIG. 3.

Referring to FIG. 3, it could be confirmed that the initial charging and discharging capacities of Example and Comparative Example were not significantly different, but Comparative Example shows sharp decrease of capacity as the charging and discharging cycles go on.

It could be confirmed that when using the solid electrolytes according to exemplary embodiments of the present invention, interface resistance was reduced, and therefore, output and life time characteristic of the all-solid state battery were improved.

Further, it could be confirmed that when using the solid electrolytes according to exemplary embodiments of the present invention, although the all-solid state battery is manufactured by using a method of applying external pressure such as a dry method, the coating part was stably maintained, and therefore output and life time characteristic of the all-solid state battery were improved.

Moreover, when using the solid electrolyte according to exemplary embodiments of the present invention, stability may be improved because the core part is a sulfide-based compound can be protected from moisture and oxygen in the air. Thus, storage and use of the solid electrolyte may become easy.

The present invention having the above-described constitutions may have the following effects.

The solid electrolyte of the present invention may reduce interface resistance with an electrode, and therefore, it an all-solid state battery having high battery capacity and long life time may be provided.

Further, in the solid electrolyte of the present invention, the sulfide-based compound making the core may absorb impact when it goes through a battery manufacturing process applying external pressure, such as pressing. Thus, the coating of the solid electrolyte may be maintained without fracture.

Further, in the solid electrolyte of the present invention, volume may not be changed even after repetitive charging and discharging processes of the battery. Thus, the coating of the solid electrolyte may be stably maintained.

Further, the solid electrolyte of the present invention may protect the sulfide-based compound from oxygen and moisture in the air, and therefore, storage and manufacturing of the battery may be easy.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A solid electrolyte, comprising:
a core comprising a sulfide-based compound, and
a coating comprising an oxide-based lithium ion conductor, the coating formed on a surface of the core.

2. The solid electrolyte of claim 1, wherein the sulfide-based compound comprises at least one selected from the group consisting of Li₂S—P₂S₅, Li₁₀GeP₂S₁₂ and Li₆PS₅Cl.

3. The solid electrolyte of claim 1, wherein the oxide-based lithium ion conductor comprises at least one selected from the group consisting of LiNbO₃, Li₃PO₄, Li₂ZrO₃, Li₂WO₄, TaO₃ and Li₄SiO₄.

4. The solid electrolyte of claim 1, wherein a thickness of the coating is from about 1 to about 100 nm.

5. The solid electrolyte of claim 1, wherein the coating reduces interface resistance by inhibiting or reducing formation of a lithium ion deficient layer on the core.

6. A method for manufacturing a solid electrolyte, comprising:
forming a coating by coating an oxide-based lithium ion conductor on a core comprising a sulfide-based compound.

7. The method of claim 6, wherein the coating is performed by using a sol-gel method or a spray coating method.

8. An all-solid state battery comprising the solid electrolyte of claim 1.
